(19) United States
(12) Patent Application Publication
(10) Pub. No.: US 2013/0163270 A1
(43) Pub. Date: Jun. 27, 2013

(54) ELEVATOR CABIN LIGHTING WITH INTEGRATED EMERGENCY LIGHTING

(71) Applicant: Seth Burgin, Wayne, NJ (US)

(72) Inventor: Seth Burgin, Wayne, NJ (US)

(21) Appl. No.: 13/334,971

(22) Filed: Dec. 22, 2011

(51) Int. Cl. B66B 7/00

(52) U.S. Cl. 362/544; 362/459; 362/545; 362/546

(57) ABSTRACT

In an elevator installation, a source of electrical energy provides electrical power to a cabin lamp mounted within a cabin to illuminate the cabin during regular and emergency situations. The lamp includes a carrier having at least one terminal to receive electrical power from the source of electrical energy. A light element is coupled to the terminal and positioned on the carrier to illuminate the cabin. The lamp includes further an energy storage device positioned on the carrier and coupled to the light element to power the light element during emergency situations. The carrier, the energy storage device and the light element may be positioned within a housing of the lamp.

### BACKGROUND OF THE INVENTION

The various embodiments described herein generally relate to elevator installations. More particularly, the various embodiments described herein relate to illuminating an elevator car during normal operation and during emergency situations, e.g., during an outage of electrical power or failure of a power supply.

Buildings are typically connected to a power network to obtain the electrical energy required to power, e.g., electrical installations operating in these buildings. One example of such installations is an elevator installation. In a generally known elevator installation, a suspension medium—such as a rope or flat belt-type rope—interconnects a counterweight and a cabin, and an electrical drive motor causes the suspension medium to move in order to thereby move the counterweight and the cabin up and down along a shaft or hoistway. As operational failures or interruptions may occur, for example, a power network may experience occasional power outages, safety standards and building codes prescribe a certain performance a system or installation must achieve in case of a power outage. For example, for an elevator installation, certain codes (e.g., European Code EN81 or US Code A17.1-2010) require that auxiliary light are automatically turned on after normal car lighting power fails. Adequate lighting in a cabin helps to avoid panic if people are trapped in the cabin following a power outage.

JP 2003/335481, for example, discloses an emergency light device in addition to the cabin's lighting system. The emergency light device has a power failure sensing mechanism that senses when the power supplied to the cabin's lighting system is shut off. In that case, an auxiliary power supply energizes an emergency light composed of several light emitting diodes (LED).

Even though such an emergency light device provides lighting in case of a power failure and uses LEDs that consume less electrical energy than fluorescent or incandescent lamps, this emergency light device may not be suitable for applications that have certain design or esthetic or installation requirements, for example, because it requires additional space and wiring. There is, therefore, a need for an alternative technology for illuminating a cabin during emergency situations.

### SUMMARY OF THE INVENTION

Accordingly, on aspect of such an alternative technology involves a cabin lighting or lamp in which the functions of illuminating the cabin during regular operation and of illuminating the cabin during emergency situations are integrated into a single module; that single module constitutes the cabin lighting or lamp. The module includes besides at least one light source an energy storage device that provides electrical energy for the emergency lighting.

More particularly, the technology involves an elevator cabin lamp for mounting within a cabin of an elevator installation to illuminate the cabin during regular and emergency situations, wherein the elevator installation is configured to provide electrical power from a source of electrical energy to the cabin lamp. The cabin lamp includes a carrier having at least one terminal to receive electrical power from the source of electrical energy, and a light element coupled to the terminal and positioned on the carrier to illuminate the cabin. Further, the cabin lamp includes an energy storage device positioned on the carrier and coupled to the light element to power the light element during emergency situations.

Another aspect of the alternative technology involves an elevator installation having a cabin and a lighting device mounted within the cabin and coupled to a source of electrical energy. The lighting device is configured to illuminate the cabin during regular operations and emergency situations. It includes a carrier having at least one terminal to receive electrical power from the source of electrical energy, and a light element coupled to the terminal and positioned on the carrier to illuminate the cabin through the transparent section. The lighting device includes further an energy storage device positioned on the carrier and coupled to the light element to power the light element during emergency situations.

Advantageously, as the functions of illuminating the cabin during regular operation and during emergency situations are integrated into a single lamp housing, no additional space or wiring are required for a separate emergency lighting. With the installation of the cabin lighting, the emergency lighting is installed as well in one installation step.

In one embodiment, the light element is based on light emitting diode (LED) technology. LED technology has proven its suitability for purposes of illumination in a variety of applications, in particular because it allows manufacture of light elements that have a low form factor (i.e., light elements with LEDs allow a variety of designs that have small housings), are long-lasting, and consume a reduced amount of energy and, hence, generate only minimal heat. In addition, LEDs switch on rapidly resulting in a startup without delay.

Advantageously, the integration of the functions can be implemented in a cabin lighting that is provided with or without housing. If a housing is provided, at least the light element and the energy storage device are positioned within the housing. If no housing is provided, the cabin lighting may be placed in a recess which is then covered by a separate cover.

An additional advantage is that several concepts for configuring the cabin lighting are available. Each light source of the light element is used during regular and emergency situations; during an emergency situation, however, the light sources may be operated with a shorter duty cycle (e.g., shorter pulses). Or, of the light sources used for regular operation of the light element only some of the light sources are used during emergency situations. Further, the light element may have two separate sets of light sources, a first set for regular operation and a second set for emergency situations, wherein only the second set is coupled to the power storage device for use during an emergency situation.

### BRIEF DESCRIPTION OF THE SEVERAL VIEWS OF THE DRAWINGS

The novel features characteristic of the invention are set out in the claims below. The invention itself, however, as well as other features and advantages thereof, are best understood by reference to the detailed description, which follows, when read in conjunction with the accompanying drawings, wherein:

FIG. 1 shows a schematic illustration of one embodiment of an elevator installation having a cabin with cabin lighting;

FIG. 2 is a schematic illustration of one embodiment of a lamp for use in the cabin lighting shown in FIG. 1;

FIG. 3 is a schematic illustration of one embodiment of an electrical circuitry for driving light sources of the lamp shown in FIG. 2; and

FIG. 4 is another schematic illustration of one embodiment of an electrical circuitry for driving light sources of the lamp shown in FIG. 2.

### DETAILED DESCRIPTION OF THE INVENTION

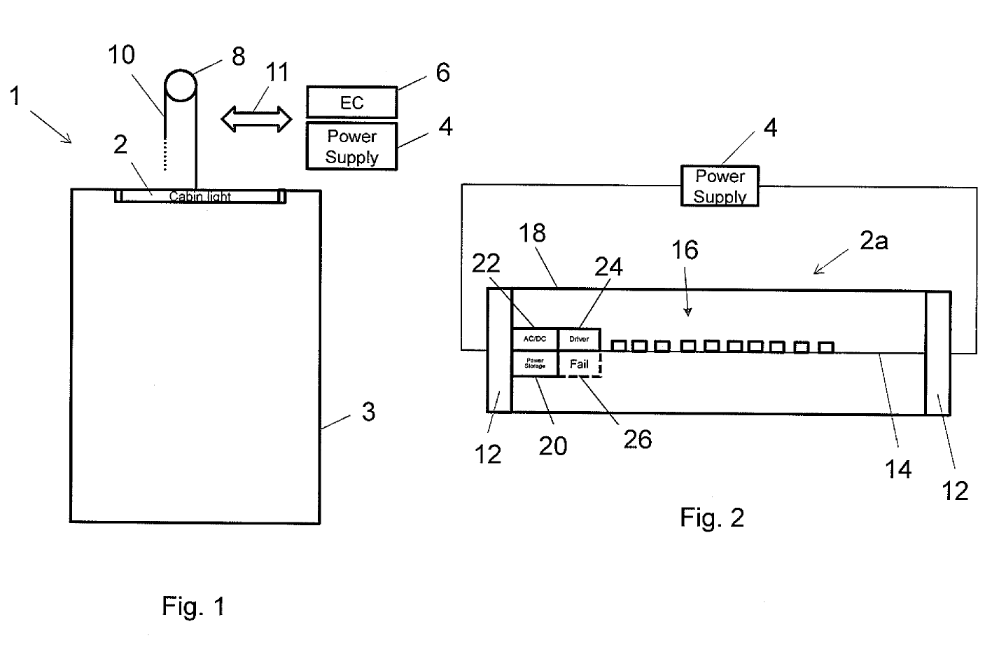

FIG. 1 schematically illustrates one embodiment of an elevator installation 1 installed in a building. The elevator installation 1 includes a cabin 3 connected via a suspension medium 10 (e.g., one or more round ropes or flat belt-type ropes) to a counterweight (not shown), wherein the cabin 3 and the counterweight are movable up and down in opposite directions in a vertically extending shaft or hoistway. A drive 8 is coupled to the suspension medium 10 and configured to act upon the suspension medium 10 to move the cabin 3 and the counterweight. In one embodiment, the elevator installation 1 is a traction-type elevator, i.e., a drive sheave coupled to the drive 8 acts upon the suspension medium 10 by means of traction between the drive sheave and the suspension medium 10. In such an embodiment, the suspension medium 10 serves as a suspension and traction medium. The skilled person, however, will appreciate that any kind of elevator installation may be used in connection with the illumination technology described herein.

The elevator installation 1 includes further a control unit 6 (in FIG. 1 labeled as EC for elevator control) and a power supply 4 that interact with various components of the elevator installation 1, as indicated through a double arrow 11 in FIG. 1. The power supply 4 provides electrical power to the elevator installation 1 and may be viewed as an interface to a power network, e.g., a public power network. The control unit 6 is configured to control and monitor the performance and operation of the elevator installation 1, as is known in the art.

The cabin 3 includes a cabin lighting 2 coupled to the power supply 4. The cabin lighting 2 is typically mounted at the cabin ceiling to achieve optimized illumination of the cabin's interior. The mounting of the cabin lighting 2 may be chosen in view of design, esthetic or technical considerations, including maintenance and service considerations from within the interior of the cabin 3. For example, the cabin lighting 2 may be mounted in a recess which may be covered with a transparent cover for protection or design reasons, or the cabin lighting 2 may be part of a housing mounted to the cabin ceiling. Preferably, these mounting options allow easy and uncomplicated access by service personnel, e.g., for cleaning and lamp replacement. It is contemplated that depending on a particular configuration of the cabin 3, one or more cabin lightings 2 may be provided for illuminating the cabin interior.

In one embodiment, the cabin lighting 2 includes a base fixture mounted to the cabin 3 and a lamp. The base fixture is usually fixedly mounted to the cabin 3 (e.g., to the ceiling) and serves as an interface between the power supply 4 and the lamp. The lamp is removably coupled to the base fixture and may have a variety of different configurations. For example, the lamp used in the cabin lighting 2 of FIG. 1 may have a tubular shape, e.g., similar to that of a known T8 or T12 fluorescent lamp. Such a tube shaped T8 or T12 lamp with electrodes on each end cap can be unplugged from its base fixture. Alternatively, a bulb shaped lamp with an E14 or E27 male screw base may be screwed into a corresponding socket of its base fixture. Generally, it is contemplated that the lamp may have one of a variety of form factors, wherein a connecting part of the lamp and the base fixture are configured for a selected form factor.

One embodiments of the cabin lighting 2 may not have a separate base fixture. Instead, lamp and base fixture are integrated into a single module configured to be directly mounted to the cabin. The supply of electrical energy occurs in that case, e.g., via wires that are connected to the module after mounting it to the cabin 3.

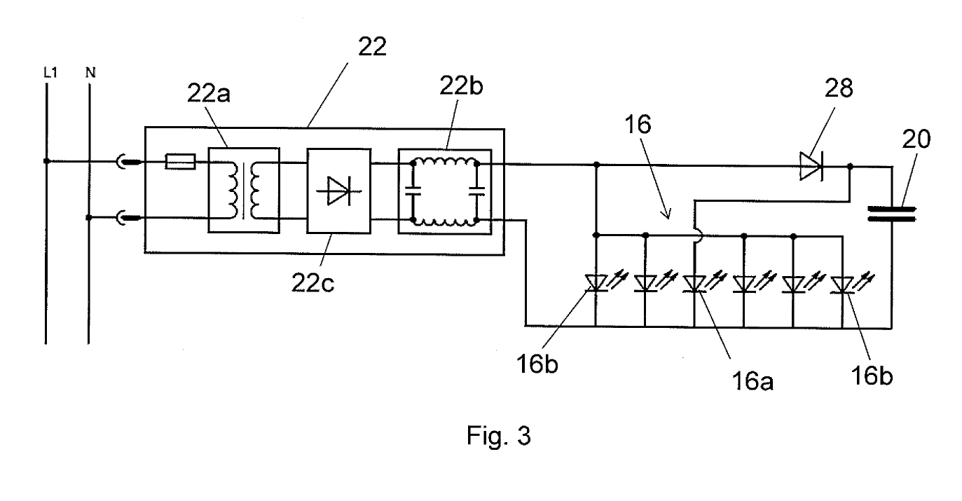

FIG. 2 shows a schematic illustration of one embodiment of a lamp 2a for use in the cabin lighting 2 shown in FIG. 1. For ease of illustration, the lamp 2a is depicted as being connected to the power supply 4; a separate base fixture that holds the lamp 2a and couples the lamp 2a to the power supply 4 is not shown in FIG. 2. As such, the lamp 2a may in one embodiment be viewed as the single module that constitutes the cabin lighting 2.

The lamp 2a has a tubular shape with end caps 12 on opposite ends of the tubular shape. Electrodes that are integrated into the end caps 12 to allow provisioning of electrical energy to the lamp 2a are not shown. It is contemplated that the electrodes may be integrated into only one end cap 12. A cover 18 extends between the two end caps 12. The cover 18 allows passage of visible light and may be clear or tinted depending on a particular application and/or illumination requirements. Similarly, the cover 18 may be made of glass or a plastic material. In one embodiment, the cover 18 may be configured to modify light, e.g., to direct light in a desired direction. As such, at least a part of the cover 18 may have the function of an optical lens.

In the illustrated embodiment of FIG. 2, the cover 18 and the end caps 12 form a housing of the lamp 2a. Within that housing, the lamp 2a includes at least one light element 16 mounted and electrically coupled to a carrier 14. The carrier 14 is coupled to the electrodes integrated in at least one of the end caps 12 to supply electrical energy to the light element 16. At least a part of the carrier 14 may be configured as a printed circuit board (PCB) to allow mounting of electrical components directly on to the board minimizing wiring complexity.

In accordance with one embodiment, the housing includes not only the light element 16 and the carrier 14, but also other electrical components to operate the light element 16 during regular and emergency situations. Ideally, most or all electrical components necessary to drive the light element 16 during these situations are integrated into the lamp 2a. It is contemplated, however, that the degree of integration may vary depending on various factors, such as form factor (e.g., available space within the housing), design aspects and thermal considerations (e.g., generated heat within the housing).

In another embodiment, the cabin lighting 2 does not have a housing with a cover, for example, in case the cabin lighting 2 is mounted in a recess of the cabin ceiling. After installation of the cabin lighting 2, a separate cover may be placed over the recess to cover it and to thereby protect the cabin lighting 2 from any act of vandalism, if necessary. The concept of integrating most or all electrical components necessary to operate the light element 16 during regular and emergency situations into the cabin lighting 2, however, is maintained.

In the embodiment of FIG. 2, the housing includes a power storage device 20, an AC/DC converter 22, a driver circuit 24 and an optional circuit 26 to detect and react upon a failure, such as a power failure. The circuit 26 is depicted with dashed lines to indicate that it is optional. In FIG. 2, these components are positioned on the left side of the lamp 2a, above and below the carrier 14. In another embodiment, the components may be positioned at other locations within the housing, e.g., below and distributed along the length and width of the carrier 13, or on both the left and right side, or a combination thereof. In other embodiments, depending on size and electrical characteristics, at least some of the components may be positioned within one or both end caps 12.

The AC/DC converter 22 is coupled via the electrodes of the lamp 2a to the elevator installation's power supply 4 and supplies electrical energy to the components of the lamp 2a. The power supply 4 supplies an AC voltage of about 120 V or 240 V, which the AC/DC converter 22 converts to a DC voltage of a predetermined value, e.g., 12 V, or 24 V, or any other value depending on voltage requirements of the other components in the lamp 2a.

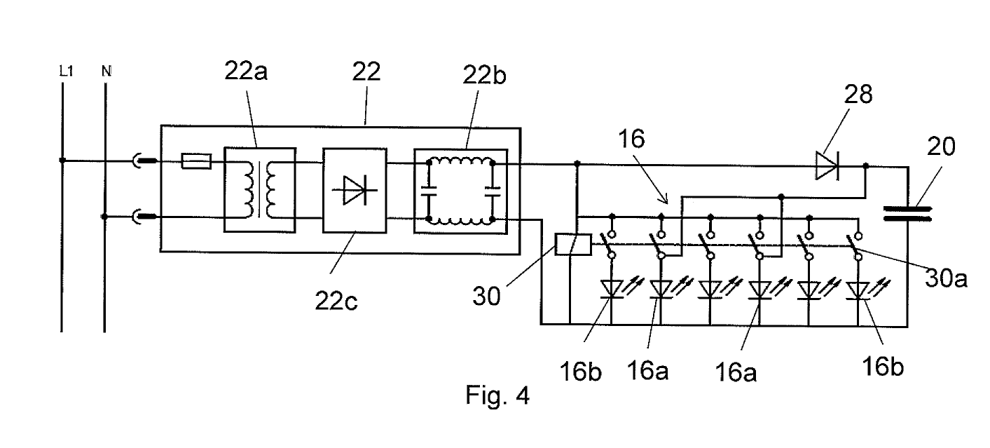

The driver circuit 24 is coupled to the AC/DC converter 22, e.g., via leads on a PCB section of the carrier 14, and to the light element 16. The driver circuit 24 activates and deactivates the light element 16 and supplies a predetermined current or voltage to the light element 16. Similarly, the power storage device 20 is coupled to the AC/DC converter 22, to the light element 16 and to the driver circuit 24, wherein the latter coupling is not shown in FIGS. 3 and 4. The power storage device 20 may include one or more capacitors (e.g., arranged in a capacitor bank), e.g., each configured as a so-called super-capacitor, or one or more batteries, or a capacitor-battery combination. The capacity of the power storage device 20 is selected to allow operation of the lighting 2 as an emergency lighting for a predetermined length of time, e.g., at least four hours as defined in US Code A17.1-2010.

If provided, the circuit 26 is also coupled to the AC/DC converter 22 to be able to detect a voltage drop to about zero, e.g., if the power supply 4 fails to provide electrical energy, or if the AC/DC converter 22 fails. In response to such failure, the circuit 26 causes electrical energy, e.g., via a relay, to be provided from the power storage device 20 to the light element 16. The skilled person will appreciate that in certain embodiments the circuit 26 is optional since the power storage device 20 may be coupled directly to the light element 16.

Preferably, the light element 16 includes at least one LED, which is mounted on the carrier 14. Typically, however, more than one LED is necessary to achieve a desired or prescribed light intensity (measured in lumens, candela or lux) within the cabin 3, in particular for emergency (auxiliary) lighting. LEDs and suitable drive circuits (together with technical specifications and application sheets) are commercially available, whereas LEDs are further known for their low energy consumption and longevity. For example, LEDs are available in the form of LED strips or bands, wherein the LEDs are mounted on a common carrier and already interconnected to facilitate handling and installation. LED drive circuits and LEDs suitable for a particular illumination purpose may be selected based on the technical specification and application sheets. Further, some LED modules are available that include a set of LEDs, drive circuitry and a power converter for direct connection to a power line.

As mentioned above, the lamp 2a integrates the functions for regular operation and operation during emergency situations. For these functions, the light element 16 and the associated components such as the power storage 16 and the driver circuitry 24 may be configured in different ways:
Each light source (e.g., LED) of the light element 16 is used during regular and emergency situations; during an emergency situation, however, the light sources may be operated with a shorter duty cycle (e.g., shorter pulses). For example, in one embodiment, the drive circuit 24 may be set for a 50% duty cycle for regular operation, and then to half of that during an emergency situation.
Of the light sources used for regular operation of the light element 16, only some of the light sources are used during emergency situations. Only these light sources are coupled to the power storage device 20 to receive electrical energy during an emergency situation.
The light element 16 includes two separate sets of light sources, a first set for regular operation and a second set for emergency situations, wherein only the second set is coupled to the power storage device 20 for use during an emergency situation.

FIG. 3 is a schematic illustration of one embodiment of an electrical circuitry for operating light sources of the lamp 2a shown in FIG. 2. The electrical circuitry shows in more detail the individual components of the AC/DC converter 22, the power storage device 29 and the light element 16. In this embodiment, there is no circuit 26 to detect a failure, and the function of driving the light element 16 is integrated into the AC/DC converter 22.

The AC/DC converter 22 includes a transformer 22a coupled via electrodes to power lines L1, N, and is configured to transform the AC power supply voltage at its input terminal to a lower AC voltage at its output terminals. A rectifier 22c is coupled to the output terminals, and is configured to generate a (e.g., pulsating) DC voltage, which is fed to a subsequent circuit 22b for smoothing. The general structures of and design rules for the rectifier 22 and the circuit 22b are known to the skilled person. In the illustrated embodiment, the AC/DC converter 22 provides a DC voltage having a voltage selected to directly drive LEDs of the light element 16.

A first set of LEDs 16b of the light element 16 is coupled (in parallel) to the AC/DC converter 22. A second set of LEDs 16a is coupled to the power storage device 20, which is indicated by means of a symbol for a capacitor. The second set of LEDs includes in FIG. 3 only one LED 16a, however, more than one may be provided. A blocking diode 28 is coupled between the AC/DC converter 22 and the power storage device 20. The blocking diode 28 allows charging the capacitor (20) during regular operation, but prevents discharging via the AC/DC converter 22 in failure situations. In these situations, a discharge current flows from the capacitor 22 through the LED 16a of the second set to activate the LED 16a. It is contemplated that the second set of LEDs 16a may include may include more than one LED to achieve a desired illumination of the cabin 3.

FIG. 4 in case of another schematic illustration of one embodiment of an electrical circuitry for operating the light sources of the lamp 2a shown in FIG. 2. This embodiment has a structure that corresponds in principal to the structure of the embodiment shown in FIG. 3; therefore, only the differences between these embodiments are described here. A relay 30 is connected in parallel to the output terminals of the AC/DC converter 22. The relay 30 controls contacts 30a, each interconnected between a terminal of an LED 16a, 16b and an output terminal of the AC/DC converter 22. During regular operation, the contacts 30a are closed; a failure causes the relay 30 to become deactivated and the contacts 30a open (as shown in FIG. 4) decoupling the LED terminals from the AC/DC converter 22. In a failure situation, a discharge current flows from the capacitor 22 through the LEDs 16a (two are shown) of the second set to activate the LEDs 16a. As shown in FIG. 4, the LEDs 16a remain connected to the capacitor even in the contacts 30a open.

The skilled person will appreciate that at least some of the electronic components of the cabin lighting 2 are configured as integrated circuits that are packaged in housings for easy handling and achieving a low form factor. Further, the skilled person will appreciate that several integrated circuits may be combined into a single module, e.g., a module that interfaces the power supply 4 and the light element 16 and is Thither coupled to the energy storage device 20. In that way, the space requirements of the electronic components are minimized, and positioning and integrating these components on the carrier 14, with or without housing, is facilitated.

It is apparent that there has been disclosed a technology for an emergency lighting that filly satisfy the objects, means, and advantages set forth herein before. For example, the installation of an emergency lighting system becomes the installation of a cabin lighting 2 that is configured to perform two functions, namely, illuminating the cabin during normal operation and providing an emergency or auxiliary lighting during emergency situations. The need for the separate installation of an emergency lighting is removed.

What is claimed is:

1. An elevator cabin lamp for mounting within a cabin of an elevator installation to illuminate the cabin during regular and emergency situations, wherein the elevator installation is configured to provide electrical power from a source of electrical energy to the cabin lamp, comprising:
a carrier having at least one terminal to receive electrical power from the source of electrical energy;
a light element coupled to the terminal and positioned on the carrier to illuminate the cabin; and
an energy storage device positioned on the carrier and coupled to the light element to power the light element during emergency situations.

2. The lamp of claim 1, further comprising a housing having a section configured to allow passage of visible light, wherein the carrier, the light element and the energy storage device are positioned within the housing.

3. The lamp of claim 2, wherein the housing has a tubular shape with opposite ends, at least one end comprising a terminal to connect to the source of electrical energy.

4. The lamp of claim 1, wherein the light element includes at least one light emitting diode.

5. The lamp of claim 4, further comprising a drive circuit positioned on the carrier and coupled to the light emitting diode.

6. The lamp of claim 1, wherein the light element includes a plurality of light sources, wherein at least one of the light sources is coupled to the energy storage device to obtain electrical energy from the energy storage to illuminate the cabin during emergency situations.

7. The lamp of claim 6, wherein each light source is coupled to the energy storage device.

8. The lamp of claim 7, wherein each light source includes a light emitting diode.

9. The lamp of claim 1, wherein the light element includes a first set of light sources and a second set of light sources, wherein the first set of light sources is coupled to the terminal to be powered during normal operation, and wherein the second set of light sources is coupled to the energy storage device to obtain electrical energy from the energy storage to illuminate the cabin during emergency situations.

10. The lamp of claim 1, wherein the energy storage device comprises one of a battery and a capacitor.

11. The lamp of claim 10, wherein at least the second set of light sources includes light emitting diodes.

12. The lamp of claim 1, further comprising a control circuitry coupled to the light element and the energy storage device and configured to drive the light element.

13. An elevator installation, comprising:
a cabin;
a lighting device mounted within the cabin and coupled to a source of electrical energy, wherein the lighting device is configured to illuminate the cabin during regular operations and emergency situations, and comprises:
a carrier having at least one terminal to receive electrical power from the source of electrical energy;
a light element coupled to the terminal and positioned on the carrier to illuminate the cabin through the transparent section; and
an energy storage device positioned on the carrier and coupled to the light element to power the light element during emergency situations.

14. The installation of claim 13, wherein the lighting device further comprises a housing having a section configured to allow passage of visible light, wherein the carrier, the light element and the energy storage device are positioned within the housing.

15. The installation of claim 14, wherein the housing has a tubular shape with opposite ends, at least one end comprising a terminal to connect to the source of electrical energy.

16. The installation of claim 13, wherein the light element includes at least one light emitting diode.

17. The installation of claim 16, further comprising a drive circuit positioned on the carrier and coupled to the light emitting diode.

18. The installation of claim 13, wherein the light element includes a plurality of light sources, wherein at least one of the light sources is coupled to the energy storage device to obtain electrical energy from the energy storage to illuminate the cabin during emergency situations.

19. The installation of claim 13, wherein the light element includes a first set of light sources and a second set of light sources, wherein the first set of light sources is coupled to the terminal to be powered during normal operation, and wherein the second set of light sources is coupled to the energy storage device to obtain electrical energy from the energy storage to illuminate the cabin during emergency situations.
